(19) United States
(12) Patent Application Publication
(10) Pub. No.: US 2025/0053852 A1
(43) Pub. Date: Feb. 13, 2025

(54) Reducing Size of a Machine-Trained Model to Facilitate Storage and Transfer

(71) Applicant: Microsoft Technology Licensing, LLC, Redmond, WA (US)

(72) Inventors: Mohsen FAYYAZ, Berlin (DE); Eric Chris Wolfgang SOMMERLADE, Oxford (GB); Marcelo GENNARI DO NASCIMENTO, London (GB); Ebey Paulose ABRAHAM, Oxford (GB)

(73) Assignee: Microsoft Technology Licensing, LLC, Redmond, WA (US)

(21) Appl. No.: 18/232,465

(22) Filed: Aug. 10, 2023

(51) Int. Cl. G06N 20/00; H04L 67/00

(52) U.S. Cl. CPC G06N 20/00; H04L 67/34

(57) ABSTRACT

A data structure describes a machine-trained model using a data structure that includes a plurality paths between a root node and respective leaf nodes. One such path is a main root-to-leaf (RTL) path, while other paths are referred to as non-main-RTL paths. Each node along the RTL path is associated with a portion of base model weights. At least one node along a non-main-RTL path is associated with a portion of model-variance information. A training system trains the portions of model-variance information as variations of corresponding portions of base model weights, while keeping the portion of base model weights fixed. In some cases, a local system obtains portions of model weights described by the data structure from a source system on an as needed-basis. The above characteristics contribute to the efficient storage, transfer, and execution of the machine-trained model.

### BACKGROUND

An increasing number of applications incorporate language models. However, this type of technology is resource-intensive in nature. This makes it technically challenging for an application to locally implement a large language model. For instance, a local execution platform may not have sufficient storage and memory capacity to store and execute a large language model. Further, it takes a significant amount of time for a local execution platform to download the weights of a large language model from an online source.

To address these issues, an application can interact with a server-side implementation of a large language model. This solution, however, is not ideal. An application provider may wish to limit interaction with network-accessible resources for privacy-related reasons. Further, interaction with network-accessible resources incurs latency-related costs.

### SUMMARY

In some implementations, a source system (and/or a local system) stores a data structure that describes a machine-trained model. The data structure includes a plurality paths from a root node to respective leaf nodes. The different paths represent different sequences of processing blocks in the execution of the machine-trained model. One such path is a main root-to-leaf (RTL) path, while other paths are referred to as non-main-RTL paths. Each node along the RTL path is associated with a portion of base model weights. At least one node along a non-main-RTL path is associated with an instance of model-variance information. A training operation defines portions of base model weights to produce prescribed behavior of the machine-trained model. The training operation defines portions of model-variance information to produce variations of the prescribed behavior with less information compared to the portions of base information.

According to one illustrative aspect, each portion of model-variance information associated with a particular model part includes a portion of model-variance weights. Alternatively, each portion of model-variance information includes an instance of machine-trained input information to be supplied to the particular model part upon its execution. The input information provides context that influences the processing operations performed by the model part.

According to another illustrative aspect, a training system first trains the portions of base model weights, and then trains the portions of model-variance information, while keeping the portions of base model weights fixed.

According to another illustrative aspect, a technique is described herein for successively receiving portions of model-variance information from the source system, which stores a complete version of the above-summarized data structure. The technique further includes successively executing model parts based on the portions of model-variance information received from the source system, together with corresponding portions of base model weights.

According to one illustrative aspect of the technique, the local system is initialized to store the portions of base model weights.

The characteristics summarized above contribute to various advantageous technical effects. For instance, each portion of model-variance information is considerably smaller in size compared to its counterpart portion of base model weights. The reduction in model size reduces the total amount of storage space necessary to store the machine-trained model, and reduces the amount of memory required to execute the machine-trained model. This characteristic has advantages in many contexts, but is particularly useful for the case in which a resource-constrained local system is the platform that executes the machine-trained model. The reduction in model size also expedites the transfer of model-variance information to the local system; that is, by reducing the size of the amount of data to be transferred, the technique reduces the time required to perform this task. The above-summarized technique of executing model parts is performed on an as-needed basis, which further contributes the efficient implementation of the machine-trained model.

This Summary is provided to introduce a selection of concepts in a simplified form; these concepts are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

FIG. 1 shows a data structure provided by a source system (and/or a local system) for representing portions of model-part information of a machine-trained model.

FIG. 2 shows a model part for executing a portion of base model weights obtained from a source system.

FIG. 3 shows a model part for executing a portion of model-variance information in conjunction with a portion of base model weights.

FIG. 4 shows an execution framework for downloading portions of model-part information from a source system to a local system, and executing a machine-trained model at the local system based on the portions.

FIG. 5 shows an execution component, which corresponds to a model part of a machine-trained model.

FIG. 6 shows logic for implementing a sequence of model parts, the model parts being associated with one path through the data structure of FIG. 1.

FIG. 7 shows an implementation of the local system of FIG. 4 as a single local computing device.

FIG. 8 shows an implementation of the local system of FIG. 4 as plural local computing devices.

FIG. 9 shows one implementation of a training system for training a machine-trained model.

FIG. 10 shows logic for executing a forward pass in a training operation based on a portion of base model weights and a portion of model-variance weights. The result of these calculations is used to update the portions of model-variance weights.

FIG. 11 shows one manner of operation of the training system of FIG. 9.

FIGS. 12-14 are flowcharts that summarize the operation of the execution framework of FIG. 4 in three different ways.

FIG. 15 shows computing equipment that, in some implementations, is used to implement the execution framework of FIG. 1.

FIG. 16 shows an illustrative type of computing system that, in some implementations, is used to implement any aspect of the features shown in the foregoing drawings.

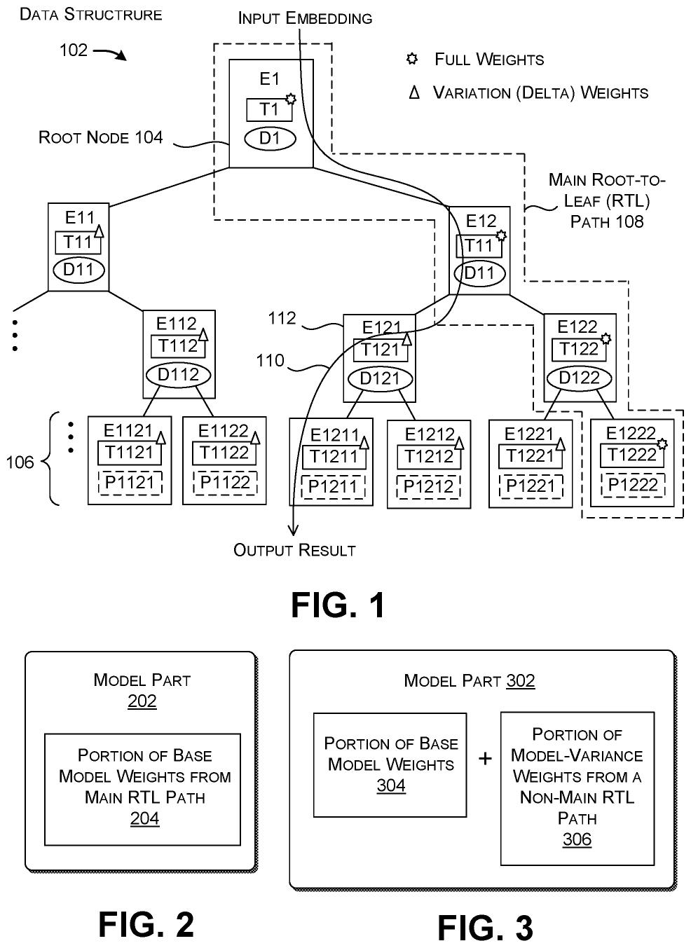

The same numbers are used throughout the disclosure and figures to reference like components and features. Series 100 numbers refer to features originally found in FIG. 1, series 200 numbers refer to features originally found in FIG. 2, series 300 numbers refer to features originally found in FIG. 3, and so on.

### DETAILED DESCRIPTION

### A. Illustrative Data Structure

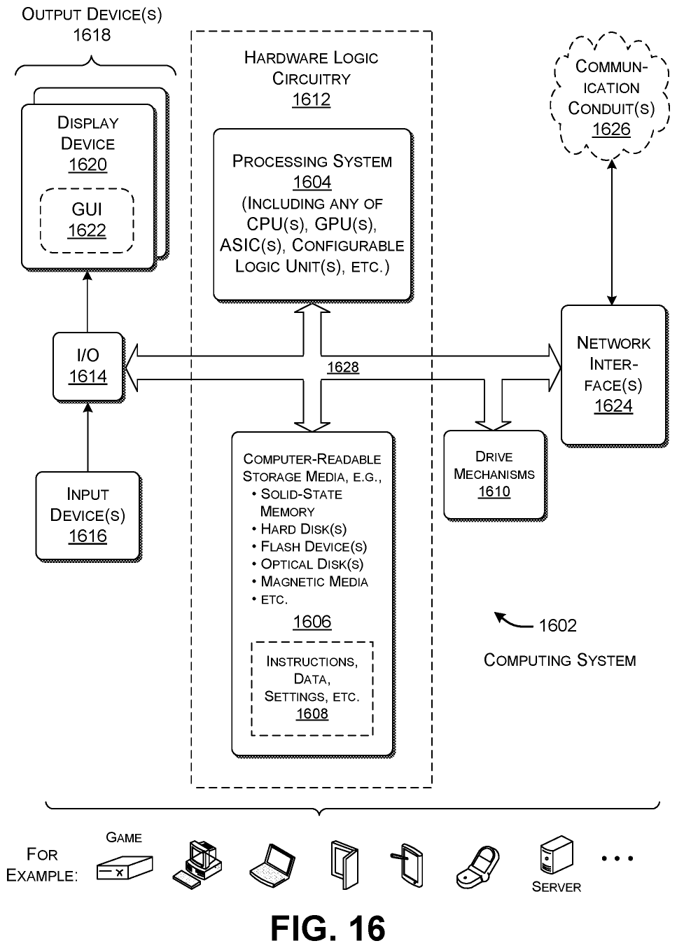

FIG. 1 shows a data structure 102 for representing the weights of a machine-trained model (“model” for brevity). By way of terminology, a “machine-trained model” refers to computer-implemented logic for executing a task using machine-trained weights that are produced in a training operation. A “model part” corresponds to part of a model, such as a transformer block of a transformer-based model. A “weight” or “model weight” refers to any type of parameter value that is iteratively produced by the training operation. A “token” is a unit of information processed by the machine-trained model, such as a word or a part of a word. In some contexts, terms such as “component,” “module,” “engine,” and “tool” refer to parts of computer-based technology that perform respective functions. FIGS. 15 and 16, described below, provide examples of illustrative computing equipment for performing these functions.

In some implementations, the model described herein is a language model that processes text-based tokens. In other implementations, the model is multi-modal in nature, and is capable of processing any type, or combination of types, of tokens. For example, in some implementations, the model processes input information that includes any combination of language-based tokens, image-based tokens, video-based tokens, audio-based tokens, etc. For example, image-based tokens correspond to patches of an image of size n×m pixels. To facilitate explanation, however, the following explanation presents examples in which the model processes text-based tokens.

In some implementations, the data structure 102 includes a graph of nodes connected by links. Each node represents a portion of model-part information associated with a model part of the machine-trained model. In some cases, the data structure 102 incorporates the portions of model-part information associated with its nodes. In other cases, the data structure 102 includes pointers or other references that point to locations at which the portions of model-part information are stored. In other cases, each portion of model-part information has a node identifier that identifies its relation to other nodes in the data structure 102. Collectively, these identifiers constitute the data structure 102, without the need for information that describes the links.

Each link represents a possible flow in the execution of model parts. For example, the data structure 102 shown in FIG. 1 takes the specific form of a hierarchy of nodes. An execution system (not shown) is expected to first execute a model part that uses the model-part information associated with a root node (E1) 104. The execution system is then expected to execute a model part associated with either node E11 or node E12, but not both. Assume that the execution system executes a model part associated with node E12. The execution system is then expected to execute a model part associated with node E121 or node E122, but not both. This process continues until the execution system executes a model part associated with a terminal (leaf) node of the tree, at which time the execution system provides a final output result. The leaf node is one of a plurality of leaf nodes 106.

There are a plurality of possible ways to traverse the data structure 102 from the root node (E1) 104 to one of the plurality of leaf nodes 106. A main root-to-leaf (RTL) path 108 involves, in order, the traversal of the root node (E1) 104, node E12, node E122, and leaf node E1222. Other paths between the root node (E1) 104 and respective leaf nodes 106 are referred to as non-main RTL paths. An example of a non-main RTL path is path 110, which involves, in order, the traversal of nodes (E1) 104, E12, E121, and E1211.

The term “model-part information” encompasses any information that serves to configure a model part, and which governs the behavior of the model part during execution. A portion of model-part information, for instance, corresponds a portion of machine-trained model weights. In other cases, a portion of model-part information corresponds to machine-trained input information that is fed to the model part during execution. For example, the machine-trained input information includes one or more configuration vectors that contain contextual information that, when fed to the model part during execution, govern the behavior of that model part. However, to facilitate explanation, the remainder of this section will principally describe the implementation in which each portion of model-part information corresponds to a portion of machine-trained model weights.

More specifically, each node along the main RTL path 108 includes a full portion of base model weights, while at least one node along a non-main RTL path includes a portion of model-variance information. Model-variance information corresponds to model-variance weights or machine-trained input information. For example, the non-main RTL path 110 includes a node 112 (E121) that stores a portion of model-variance weights. Note that the non-main-RTL path 110 also includes nodes E1 and E12, and therefore encompasses part of the main RTL path 108.

A training system (not shown in FIG. 1) first trains all of the base model weights in the main RTL path 108. The training system then trains all of the portions of model-variance weights in the non-main RTL paths in end-to-end fashion in a single training operation, while keeping the base model weights fixed. As a result of this training, each portion of model-variance weights in the data structure 102 can be considered a variation of an associated portion of base model weights. More generally stated, the training system defines the portions of base model weights to produce prescribed behavior of the machine-trained model during execution. The training system defines portions of model-variance information to produce variations of the prescribed behavior with less information compared to the portions of base information. During execution of the machine-trained model, an execution system executes a model part associated with a portion of model-variance weights with reference to its corresponding full portion of base model weights. The execution system executes a portion of base model weights without reference to any other portion of model weights.

In one approach, the training system trains each portion of model-variance weights by decomposing a corresponding portion of base model weights (represented by a full weight matrix W_{F}) into two smaller transformations (represented by two smaller matrices). The training system then trains the reduced-sized transformations. In another approach, the training system adds one or more additional layers to a model part, referred to as adapters. For example, the training system adds one or more layers of a fully-connected neural network on top of the model part. The training system then trains the model weights of the adapter(s), while holding the base portion of model weights fixed. In another approach, as stated above, the training system trains the values of input information that will be fed to the model part during execution. The input information does not constitute model weights because it does not directly modify the transformations performed by the model part, but rather establishes context information that governs the output result produced by the model part. As stated, however, to facilitate explanation, this section principally describes the portions of model-variance information as portions of model-variance weights.

Section C will provide additional details regarding the training techniques used to create the portions of model-variance weights. At this point, suffice it to say that each portion of model-variance weights is significantly smaller in size compared to its corresponding full base portion of model weights. This characteristic enables the data structure 102 as a whole to represent the machine-trained model with significantly reduced size, compared to the case in which all nodes associated with the machine-trained model are described by respective base portions of model weights.

As a consequence of the above characteristics, the data structure 102 enables a computing system to store the machine-trained model with a reduced amount of storage space (compared to the case in which all nodes in the data structure 102 are associated with base portions of model weights). For instance, in some cases, the data structure 102 achieves a more than hundredfold reduction in required storage (e.g., by compressing a model with a storage size of more than 350 GB to a model with a storage size of ˜4 GB). This characteristic is particularly useful in those cases in which a local system (not shown) is the execution platform that executes the model weights. The reduction in size of the data structure also reduces the amount processing and memory resources required to execute an application that uses the machine-trained model.

Further, the data structure 102 enables a source system to transfer model weights to a local system with reduced latency and reduced bandwidth. This advantage follows from two provisions. First, as will be explained more fully in Section B below, the local system can request portions of model weights on an as-needed basis during the execution of the machine-trained model. Because of this, the source system need only transfer a part of the model weights in the data structure 102, not the entirety of the model weights associated with all of its nodes. Second, the source system can transfer portions of model-variance weights for some model parts of a non-main-RTL path. A portion of model-variance information is significantly reduced in size compared to a full portion of base model weights.

Other implementations vary any aspect of the features set forth above. For instance, another implementation of the data structure 102 includes at least one parent node that has more than two child nodes. A model part associated with such a parent node chooses among the three or more child nodes. More generally, other implementations can use any type of graph to connect nodes, not limited to a hierarchical tree organization of nodes. In such a data structure, a given non-main RTL path may not include the same number of child nodes as the main RTL path 108. For example, a non-main RTL path may terminate in a leaf node in fewer “hops” than the main RTL path 108. Further, different environments can use different rules to establish what portion(s) of base model weights are associated with any given portion of model-variance weights. The training system will consider all of these factors into account when it trains the machine-trained model. For example, the training system updates the portions of model-variance weights in a manner that takes account for all of the routes that emanate from each node of the data structure 102.

FIG. 2 shows a model part 202 that executes a portion of base model weights 204. FIG. 3 shows a model part 302 that executes a portion of base model weights 304 in conjunction with a portion of model-variance weights 306. For example, in some implementations, the model part 302 executes weights produced by combining a first result produced using the portion of base model weights 304 with a second result produced using the portion of model-variance weights 306. In other cases, in advance of execution, an execution system (or some other system) combines the portion of base model weights 304 with the portion of model-variance weights 306, and then executes the resultant set of summed model weights.

### B. Illustrative Execution Framework

In some implementations, a local system is preconfigured to store the model weights associated with all of the nodes in the data structure 102. In other implementations, the local system stores some of the model weights in the data structure 102, but, at any given time, not necessarily all of the model weights. For example, the local system includes long-term storage that is preconfigured to store all of the base portions of model weights in the main RTL path 108 of FIG. 1. In addition, or alternatively, the local system can store at least frequently-used portions of model-variance weights associated with any non-main RTL paths. During execution, the local system successively downloads portions of model-variance weights on an as-needed basis (presuming the local system does not already store these portions). The local system executes a model part upon receiving all necessary model weights associated with the model part. As noted in Section A, a portion of model-variance information alternatively includes an instance of input information, rather than model-variance weights. But to facilitate explanation, this section will principally describe each portion of model-variance information as either a portion of base model weights or model-variance weights.

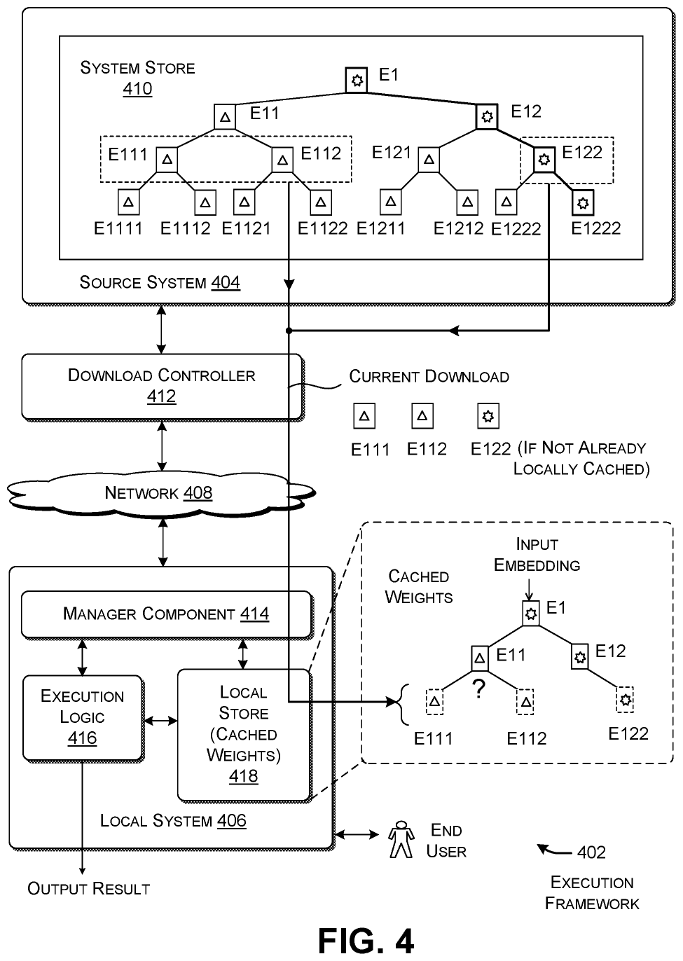

FIG. 4 shows further details regarding the last-mentioned implementation summarized above. As shown there, a source system 404 provides model weights to a local system 406. The source system 404 is implemented by one or more servers and/or other types of logic components. The local system 406 includes one or more computing devices and/or other types of logic components. For instance, in some implementations, the local system 406 includes a single local computing device of any type. In other implementations, the local system 406 includes a group of local computing devices coupled together via a local network (not shown). Although FIG. 4 only shows a single local system 406, the source system 404 provides service to plural local systems. The local system 406 is communicatively coupled to the source system 404 via a communication path. For example, the communication path is a network 408 of any type, such as the Internet.

More specifically, the source system 404 includes a system store 410 for storing model weights associated with a machine-trained model, using the data structure 102 described in Section A. To repeat, the data structure 102 includes a plurality of nodes. Each node is associated with a portion of model weights used by a model part of the machine-trained model. Some nodes are associated with portions of base model weights, while other nodes are associated with portions of model-variance weights. The source system 404 further includes (or is otherwise associated with) a download controller 412 for serving portions of model weights to the local system 406 upon request by the local system 406.

In some implementations, the local system 406 includes a manager component 414 for managing the execution of the machine-trained model. As part of its responsibilities, the manager component 414 interacts with the source system 404 to successively request portions of model weights it does not already have. Execution logic 416 executes the machine-trained model. In some implementations, the execution logic 416 includes program instructions that implement the machine-trained model, e.g., by performing the computations required by the model.

A local store 418 stores the portions of model weights obtained from the source system 404 and/or from some other source. The term “local store” is intended to broadly encompass any storage resources used by the local system 406, and therefore encompasses both short-term and long-term storage resources (e.g., both random access memory resources and disk storage resources), unless a specific form of storage is explicitly specified below. For instance, the memory resources of the local store 418 store portions of the model weights during execution of the model parts corresponding to those portions. The long-term resources of the local store 418 optionally store frequently-used portions of model weights on a longer-term basis, eliminating the need to download these portions upon each execution of the machine-trained model. A model part that is stored on a long-term basis is referred to herein as a local-model part. A particular local environment will apply environment-specific rules to determine whether to commit a portion of model weights to long-term (e.g., disk) storage.

The execution logic 416 executes a series of execution components in the course of running the machine-trained model. An execution component, in turn, is a model part that includes a transformer component and a decision component (except for a leaf execution component, which includes no decision component, but can include a post-processing component). The transformer component uses transformation weights to transform input embedding information into output embedding information. The decision component uses decision weights to decide what execution component to invoke next. The decision component then routes the output embedding information, produced by the transformer component, to the next execution component. Additional details regarding the construction and operation of an illustrative execution component will be described below in Section C.

Each portion of model weights available in the system store 410 includes a particular instance of transformation weights (designated by the symbol “T” in FIG. 1) and a particular instance of decision weights (designated by the symbol “D” in FIG. 1). For instance, the node labeled E122 includes particular transformation weights T122 and particular decision weights D122. In some implementations, an instance of transformation weights corresponds to a portion of base model weights or a portion of model-variance weights. The former is the case for node E122,

Finally, FIG. 4 shows one manner of operation of the execution framework 402 at a particular juncture in the execution of a machine-trained model. Assume that the local system 406 has already executed the model part associated with the node E1, and is currently in the process of executing the model part associated with the node E11. At this juncture, there are only two possibilities: the decision component will either invoke the model part associated with node E111 or node E112. To expedite the execution of the machine-trained model, the manager component 414 proactively requests portions of model weights for both node E112 and node E112, even before the decision component has decided which portions are to be used. In some implementations, after a routing decision has been made, the manager component 414 purges the portions of model weights that were not used. Alternatively, the manager component 414 proactively downloads more than two portions of model weights, such as the model weights associated with the nodes E111 and E112 together with the model weights associated with the children of these nodes (not shown in FIG. 1). Alternatively, the manager component 414 waits until a decision has been made, and downloads the model weights for only the next selected model part (corresponding to either E111 or E112, but not both). Still other approaches are possible to govern what model portions are to be downloaded, and when the model portions are downloaded.

Both nodes E111 and E112 are associated with portions of model-variance weights. To execute each variation portion, an execution component requires a corresponding base portion. Here, the portion of base model weights is the model weights associated with E122 of the main RTL path 108, which has the same level in data structure's hierarchy as nodes E111 and E112. (Note that this type of level-specific correspondence need not be true for all types of graphs.) In a first case, assume that the local store 418 already contains a copy of the portion of base model weights because the local store 418 was initialized to include all base model weights of the main RTL path 108, or the local system 406 has previously downloaded and stored the required portions of base model weights. In this case, the manager component 414 need only download the portions of model-variance weights associated with the nodes E111 and E112. In a second case, assume that the local store 418 does not yet contain a copy of the portion of base model weights. In this case, the manager component 414 downloads a copy of the portion of base model weights associated with node E122, as well as the portions of model-variance weights for E111 and E112.

The above-described manner of transferring model weights is efficient because a portion of model-variance weights has considerably smaller size than a portion of base model weights. As such, the manager component 414 can download a portion of model-variance weights much more quickly than a portion of base model weights. It is true that the local system 406 requires an accompanying portion of base model weights to execute a particular portion of model-variance weights. But a single portion of base model weights can be used in conjunction with two or more portions of model-variance weights. Accordingly, it is only necessary to obtain a single copy of the portion of base model weights to be combined with the plural portions of model-variance weights. Further, in some implementations, the local system 406 is initialized to store all portions of base model weights, eliminating the need to download these weights during execution.

The manager component 414 uses different rules to govern which model weights are retained in the local store 418 for potential reuse upon another execution of the machine-trained model. In some cases, the manager component 414 maintains model weights associated with the top nodes of the main RTL path 108, such as the model weights associated with nodes E1 and E12. Alternatively, or in addition, the manager component 414 maintains model weights that are frequently requested by a particular user or group of users. To perform this function, the manager component 414 maintains statistics that describe the frequency at which different model parts are used.

Overall, the execution framework 402 of FIG. 4 enables the local system 406 to execute a relatively large machine-trained model in a resource-efficient manner, compared to an alternative case in which the local system 406 downloads a complete machine-trained model and then runs it. More specifically, the streaming operation does not overburden the storage resources of the local system 406 because the local system 406 is not expected to store a complete copy of the machine-trained model's weights at any given time (although it can do so in other implementations). The streaming operation does not overburden the memory resources of the local system 406 because the local system 406 is not expected to load a large amount of model weights at any given time (although it can do so in other implementations). The streaming operation does not overburden the processing resources (including central processing units (CPUs), graphics processing units (GPUs), and neural processing units (NPUs)) of the local system 406 because the local system 406 is not expected to execute large parts of the machine-trained model at the same time. Further, the streaming operation enables the local system 406 to more quickly begin running a machine-trained model, compared to the alternative case in which all of the model weights are downloaded over the network 408 prior to execution (which may require a significant amount of load time).

### C. Illustrative Execution Component

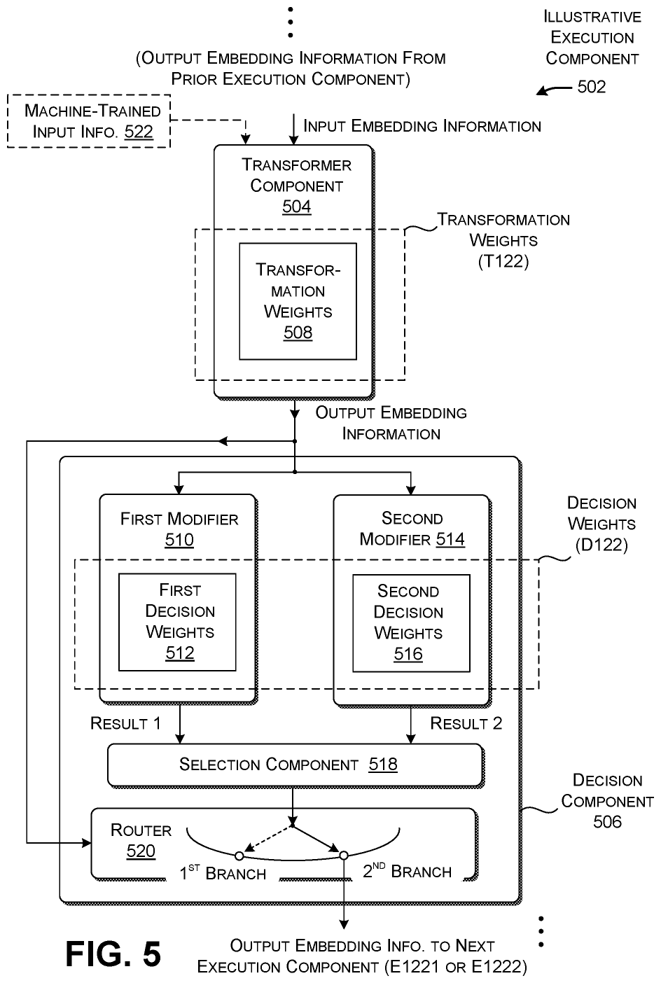

FIG. 5 shows one implementation of an execution component 502. Assume that the execution component 502 specifically uses the model weights of node E122 in the source system 404. The execution component 502 includes a transformer component 504 and decision component 506. In the following explanation, each portion of model-variance information is described as a portion of model-variance weights, but as noted above, the model-variance information can instead correspond to an instance of machine-trained input information.

The transformer component 504 uses transformation weights 508 (e.g., transformation weights T122) to map an input embedding to output embedding information, including one or more embeddings. As used herein, an “embedding” represents information in numeric form, typically as a distributed vector. A distributed vector is a vector that expresses the meaning of information using a combination of its values. This is in contrast to a sparse one-hot vector in which each dimension of the vector is assigned a particular meaning. Except for the case of the first execution component, the input embedding information originates from an upstream execution component (in this example, the execution component for node E12). As noted above, in some implementations, the transformer component 504 relies on transformer-based logic.

The decision component 506 includes a first modifier 510 for mapping the output embedding information to a first result using first decision weights 512, and a second modifier 514 for mapping the output embedding information to a second result using second decision weights 516. Together, the first decision weights 512 and the second decision weights 516 constitute the decision weights (e.g., D122) stored in the data structure 102. In some implementations, each modifier (510, 514) uses any type of neural network to perform its function, such as a fully-connected feed-forward neural network having one or more layers, followed by a Softmax function (also known as a normalized exponential function) given by (exp(zᵢ/T))/(Σᵢexp(zᵢ/T)), where zᵢ is an input number in a vector z and T is a temperature parameter (which may be set to 1.0). A selection component 518 identifies the next model part (that is, a next execution component) to invoke based on the first and second results. A router 520 sends the output embedding information produced by the transformer component 504 to the selected downstream model part.

In some implementations, the selection component 518 makes a binary decision between a first routing path and a second routing path, e.g., by selecting the first routing path if the first result is greater in magnitude than the second result, and selecting the second routing path if the second result is greater in magnitude than the first result item. This is a “hard” multiplexing criterion, meaning that the selection component 518 effectively assigns a probability of zero to all routing paths that have not been selected. If the first result equals the second result, then the selection component 518 randomly chooses a routing a path, or always chooses the first routing path (or the second routing path), or makes a selection based on any other environment-specific rule.

In some implementations, the selection component 518 implements the selecting operation using mapping logic. The mapping logic produces a mask that defines the probability associated with each possible path, which can be simplified to a value of “0” for a path that will not be taken, and a value “1” for a path that will be taken. The mapping logic multiplies the mask by the output embedding information of the transformer component 504, which effectively achieves the routing of the output embedding information to a particular path.

Other implementations of an execution component are set forth below in the co-pending patent application Ser. No. 18/116,282 (the '282 Application) by SOMMERLADE, et al., filed on Mar. 1, 2023, and entitled “Executing a Machine-Trained Model using Selectively Streamed Model Weights.” The '282 Application is incorporated by reference herein in its entirety.

In the example of FIG. 5, the transformation weights 508 constitute a full portion of base model weights. In other cases, the transformation weights 508 correspond to a portion of model-variance weights. In some implementations, the decision weights (512, 516) represent a full portion of base model weights, even though the transformation weights 508 can represent a portion of model-variance weights. In other implementations, the decision weights (512, 516) can also correspond to either a full portion of base model weights or a portion of model-variance weights. As noted above, in alternative implementations, the portions of model-variance information include portions of machine-trained input information (e.g., input information 522) instead of, or in addition, to model-variance weights.

### D. Illustrative Transformer Functionality

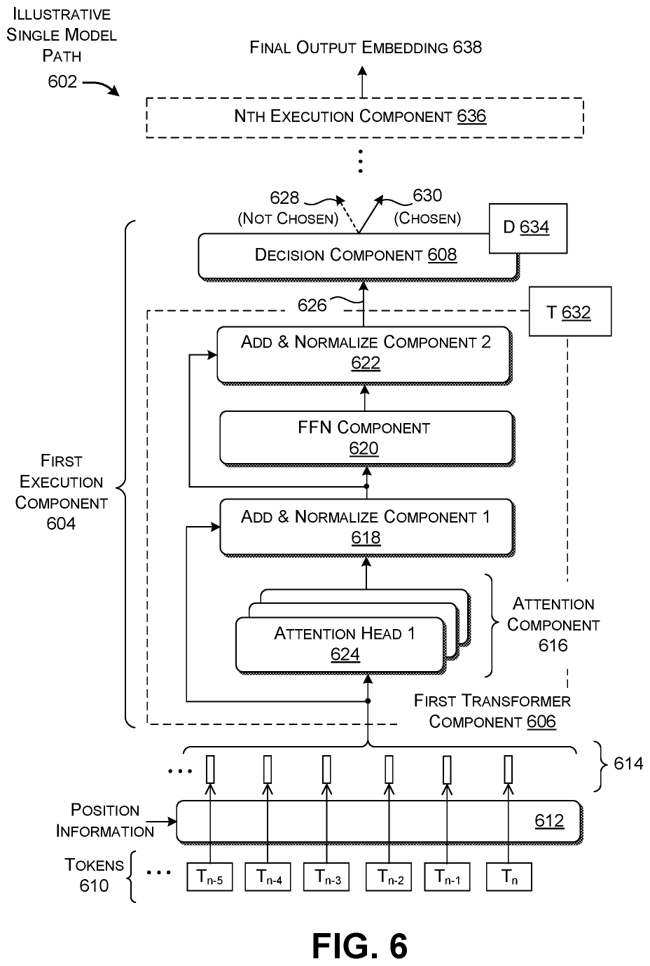

FIG. 6 shows a single model path 602 executed by the local system 406, corresponding to a single path through the more encompassing machine-trained model provided by the source system 404. The model path 602 maps initial input information to a final output result. The model path 602 includes, in part, a pipeline of execution components, including a first execution component 604 associated with the node E1. The first execution component 604 includes a transformer component 606 followed by a decision component 608. FIG. 6 also provides details regarding one way to implement the first transformer component 606. Although not specifically illustrated, other transformer components of the model path 602 have the same architecture and perform the same functions as the first transformer component 606 (but are governed by separate sets of weights).

The model path 602 commences with the receipt of input information from a source. In one implementation, the input information is a linguistic expression provided by a user or some other entity. The linguistic expression includes (or is converted into) a series of linguistic tokens 610. As used herein, a “token” or “text token” refers to a unit of text having any granularity, such as an individual word, a word fragment produced by byte pair encoding (BPE), a character n-gram, a word fragment identified by the WordPiece or SentencePiece algorithm, etc. To facilitate explanation, assume that each token corresponds to a complete word. Note that the principles set forth herein are not limited to the processing of text information; in other examples, the machine-trained model operates on any of: audio information, image information, video information, sensor information, finance-related information, and so on, or any combination thereof.

Next, an embedding component 612 maps the sequence of tokens 610 into respective token embeddings. For example, the embedding component 612 can produce one-hot vectors that describe the tokens, and can then map the one-hot vectors into the token embeddings using a machine-trained linear transformation. The embedding component 612 then adds position information (and, in some cases, segment information) to the respective token embeddings to produce position-supplemented embedding vectors 614. The position information added to each embedding vector describes the embedding vector's position in the sequence of embedding vectors.

The first transformer component 606 of the first execution component 604 operates on the position-supplemented embedding vectors 614. In some implementations, the first transformer component 606 includes, in order, an attention component 616, a first add-and-normalize component 618, a feed-forward neural network (FFN) component 620, and a second add-and-normalize component 622.

The attention component 616 performs attention analysis using the following equation:

$$attn ( Q , K , V ) = Softmax ( \frac{Q {K}^{T}}{\sqrt{d}} ) V . \qquad ( 1 )$$

The attention component 616 produces query information Q by multiplying the position-supplemented embedding vectors 614 by a query weighting matrix W^{Q}. Similarly, the attention component 616 produces key information K and value information V by multiplying the position-supplemented embedding vectors 614 by a key weighting matrix W^{K} and a value weighting matrix W^{V}, respectively. To execute Equation (1), the attention component 616 takes the dot product of Q with the transpose of K, and then divides the dot product by a scaling factor \sqrt{d}, to produce a scaled result The symbol d represents the dimensionality of Q and K. The attention component 616 takes the Softmax (normalized exponential function) of the scaled result, and then multiplies the result of the Softmax operation by V, to produce attention output information. More generally stated, the attention component 616 determines how much emphasis should be placed on parts of input embedding information when interpreting other parts (and the same parts) of the input embedding information. Background information regarding the general concept of attention is provided in Vaswani, et al., “Attention Is All You Need,” in 31st Conference on Neural Information Processing Systems (NIPS 2017), 2017, 9 pages.

Note that FIG. 6 shows that the attention component 616 is composed of plural attention heads, including a representative attention head 624. Each attention head performs the computations specified by Equation (1), but with respect to a particular representational subspace that is different than the subspaces of the other attention heads. To accomplish this operation, the attention heads perform the computations described above using different respective sets of query, key, and value weight matrices. Although not shown, the attention component 616 concatenates the output results of the attention component's separate attention heads, and then multiplies the results of this concatenation by another weight matrix W^{O}.

The add-and-normalize component 618 includes a residual connection that combines (e.g., sums) input information fed to the attention component 616 with the output information generated by the attention component 616. The add-and-normalize component 618 then normalizes the output information generated by the residual connection, e.g., by normalizing values in the output information based on the mean and standard deviation of those values. The other add-and-normalize component 622 performs the same functions as the first-mentioned add-and-normalize component 618. The FFN component 620 transforms input information to output information using a feed-forward neural network having any number of layers.

As a whole, the first transformer component 606 produces output embedding information 626. The decision component 608 processes the output embedding information 626 in the same manner previously described with reference to FIG. 5. This yields a first result and a second result. The decision component 608 chooses a first routing path 628 or a second routing path 630 based on its analysis of the first and second results. The first routing path 628 leads to a first next execution component (for node E11), while the second routing path 630 leads to a second next execution component (for node E12). Assume here that the decision component 608 chooses the second routing path 630.

Overall, the first transformer component 606 is implemented as a neural network that uses transformation weights T 632. The first decision component 608 is implemented as a neural network that uses decision weights D 634. The local system 406 downloads these weights (632, 634) from the source system 404 when needed, if not already locally stored in the local store 418. Other transformer components and other decision components use their own level-specific sets of transformation and decision weights.

A final transformer component 636 in the model path 602 (associated with a leaf node) produces a final output embedding information 638, and is not followed by a decision component. Instead, any kind of post-processing component (not shown) performs any post-processing operations on the final output embedding information 638, to produce a final output result. In one case, for instance, the post-processing component classifies the input information. In other case, the post-processing component predicts a next token to follow the input tokens, e.g., corresponding to a next word in a user's sentence that he or she is typing or speaking. In an auto-regressive mode of operation, an execution system appends the predicted token to the end of the previous sequence of tokens, and repeats the processing described above for the updated sequence of tokens. The post-processing component relies on any kind of processing logic, such as a feed-forward neural network having any number of layers, a Softmax operation, etc., or a combination thereof. FIG. 1 illustrates each set of weights associated with a post-processing component using the symbol “P.” For example, in the non-main RTL path 110, a leaf node E1211 includes a set of model weights P1211 used by a post-processing component.

Other implementations of the machine-trained model use other kinds of neural network architectures compared to the transformer-based architecture shown in FIG. 6. For instance, other implementations of the machine-trained model use a series of convolutional neural network (CNN) components. Other implementations of the machine-trained model use a series of recurrent neural network (RNN) components. Each RNN component may use a collection of long short-term memory (LSTM) units. Other implementations use stable diffusion model logic, and so on.

### E. Illustrative Local Systems

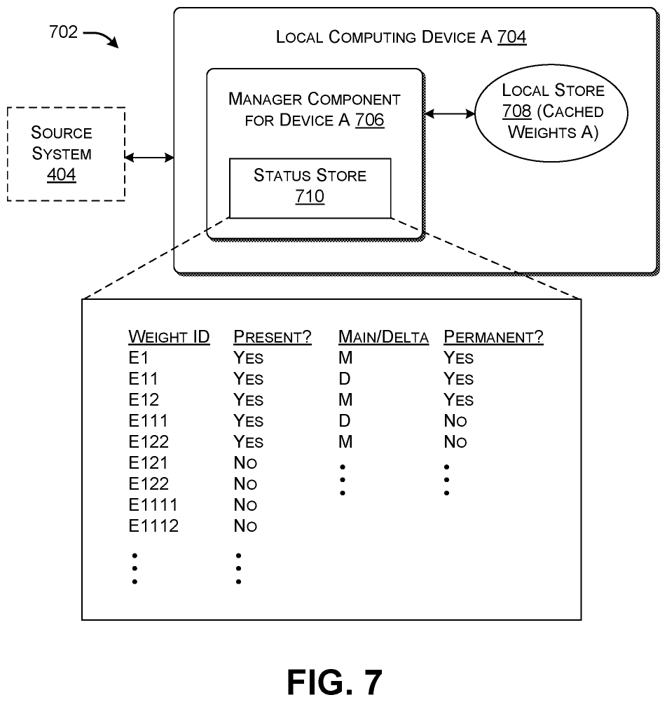

FIG. 7 shows a local system 702 of the execution framework 402 that uses a single local computing device 704. The local computing device 704 corresponds to any of a personal computing device (e.g., a desktop computing device), a handheld computing device of any type (a smartphone, tablet-type computing device, etc.), a game console, an intelligent appliance, a mixed-reality device, a dedicated home server, and so on. The local computing device 704 includes a manager component 706 and local store 708 for performing the same functions described above in Section B. The local computing device 704 obtains portions of model weights from the source system 404 in the manner previously explained. In the following explanation, each portion of model-variance information is described as a portion of model-variance weights, but as noted above, the model-variance information can instead correspond to an instance of machine-trained input information.

In some implementations, the manager component 706 maintains or otherwise has access to a status store 710. The status store 710 indicates the portions of model weights that the local store 708 currently stores, and which portions it does not store. The status store 710 also indicates whether each portion of model weights it stores is a base portion or a variation portion. The status store 710 optionally also indicates whether a portion stored in the local store 708 is designated for long-term storage. A portion that is designated for long-term storage is referred to herein as a local-part portion. When a portion has this designation, the manager component 706 will not automatically flush it from the local store 708 after its current use.

In operation, when a next portion of model weights is needed, the manager component 706 consults the status store 710 to determine whether the local store 708 already stores it. If so, the manager component 706 obtains the portion from the local store 708. If not, the manager component 706 requests the portion from the source system 404.

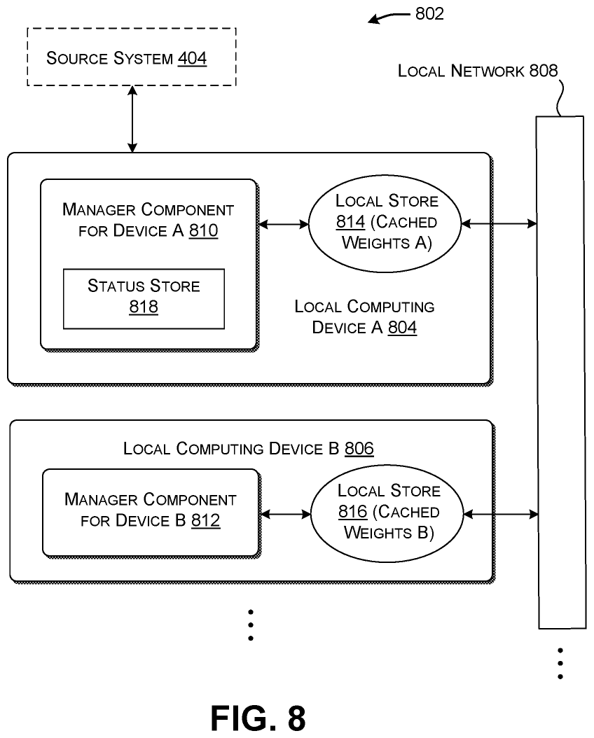

FIG. 8 shows a local system 802 in which plural local computing devices play a role in the execution of a machine-trained model. In this specific example, the local system 802 uses at least two local computing devices (804, 806) communicatively coupled via a local network 808. Each local computing device corresponds to any of the type of devices described above with respect to FIG. 7.

In some implementations, the local system 802 is configured to work in a master-slave mode, with the first local computing device 804 serving as the master agent. The first local computing device 804 includes a manager component 810 that is communicatively coupled to the source system 404. The other local computing device 806 optionally includes its own manager component 812. Further, the local computing devices (804, 806) include respective local stores (814, 816) for storing portions of model weights.

In some implementations, the manager component 810 serves as a master manager component that maintains or otherwise has access to a status store 818. The status store 818 indicates the location at which each portion of model weights is stored across the local system 802 (if in fact the portion is locally stored). The status store 818 also provides any of the metadata set forth above with respect to FIG. 7.

In operation, when a next portion of model weights is needed, the master manager component 810 consults the status store 818 to determine whether the local system 802 already stores the portion, and, if so, at which device location the local system 802 stores the portion. Assume that the status store 818 indicates that the requested portion is stored in the local store 814 of the first local computing device 804. In this case, the master manager component 810 functions as before and obtains the portion from the local store 814.

In another case, assume that the status store 818 indicates that the requested portion is stored in the local store 816 of the other local computing device 806. If so, the master manager component 810 sends an input embedding to the other local computing device 806. The input embedding corresponds to the output embedding generated by the last-invoked transformer component. The master manager component 810 instructs the other local computing device 806 to execute an execution component associated with the requested portion. The master manager component 812 further instructs the other local computing device 806 to return an output embedding, corresponding to the output of the transformer component that is run by the other local computing device 806. The local computing device 806 further conveys the model part that is to be invoked next.

Other implementations use other strategies to manage the local computing devices (804, 806). For instance, in another implementation, any of the local computing devices (804, 806) is able to assume the role of master computing device. Each local computing device has access to the same global status store. Other implementations use peer-to-peer strategies to manage interaction among the local computing devices of a local system. In some implementations, an environment can establish different rules as to what constitutes an affiliated local computing device for inclusion in a local system. For example, in an organizational environment, the local system encompasses all or some of the local computing devices of members of an organization.

Further, in some implementations, the local system 802 uses various environment-specific parameter values to govern its operation. For example, the local system 802 assigns preference values to each local computing device. If two or more local computing devices store a requested portion, then the local system 802 instructs the local computing device with the highest preference value to execute the model part associated with the requested portion. One preference rule states that a model part is to be executed by the master local computing device 804 if this device stores the required portion of model weights; this provision reduces the needless exchange of embeddings among local computing devices. Alternatively, or in addition, the local system 802 takes into account the current processing load experienced by each of the local computing devices in deciding which local computing device is asked to execute a model part (presuming that there are plural local computing devices that are able to execute the model part). In some cases, the master manager component 810 randomly chooses a local computing device to execute the requested model part if there are no factors that establish that one local computing device is more preferable than another local computing device.

### F. Illustrative Training System

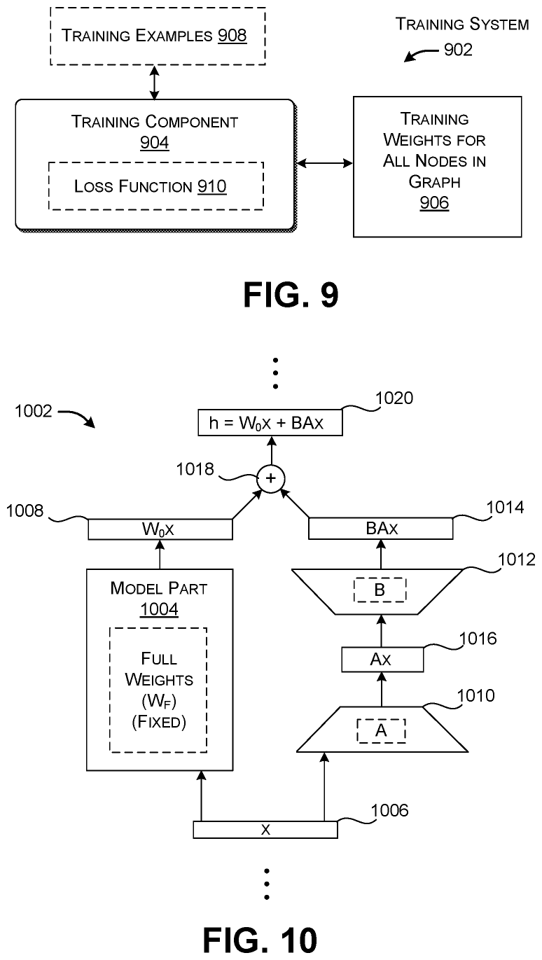

FIG. 9 shows one implementation of a training system 902 that trains the model weights 906 of a machine-trained model. In doing so, the training system 902 determines each portion of model weights in the data structure 102 shown in FIG. 1. To repeat, each portion of model weights includes an instance of transformation weights used by a particular transformer component and an instance of decision weights used by a particular decision component. A portion of model weights is either a portion of base model weights or a portion of model-variance weights. As will be described at the end of this section, the portions of model-variance information can alternatively, or in addition, include portions of input information rather than portions of model-variance weights.

The training system 902 includes a training component 904 for iteratively computing the model weights 906 based on a set of training examples 908 provided in a data store. In some implementations, each training example identifies an instance of input information together with an instance of ground-truth output information. The output information is qualified as “ground-truth” because it is considered by definition to be correct. For a given training example, the training component 904 uses the machine-trained model in its current state to generate an instance of model-generated output information. The training component 904 uses a loss function 910 to assess the extent to which the model-generated instance of output information agrees with the ground-truth instance of output information. Based on this measure, the training component 904 updates the model weights 906 of the machine-trained model. The loss function 910 uses any measure of loss, such cross entropy. In some cases, the training component 904 updates the model weights using gradient descent in combination with backpropagation.

In some implementations, the training system 902 first trains all of the model weights of the main RTL path 108 shown in FIG. 1, which include a plurality of portions of base model weights associated with different nodes along the path. In some implementations, the training system 902 specifically performs its training by fine-tuning all of the weights of a pre-trained machined-trained model, which may be produced by others. One example of a pre-trained model language model is the BLOOM model available from HUGGING FACE, INC., of New York, New York, one version of which is Version 1.3 released on Jul. 6, 2022. Alternatively, the training system 902 can use the pre-trained language model without fine-tuning it. The training system 902 next trains the portions of the model-variance weights of the data structure 102 of FIG. 1.

FIG. 10 shows illustrative training logic 1002 for training a portion of model-variance weights associated with an illustrative model part 1004. For example, the model part 1004 may represent at least part of the transformations performed by the first transformer component 606 of FIG. 6, or part thereof. A left-most path of the training logic 1002 shows a forward pass by which the model part 1004 maps input embedding information (x) 1006 associated with an input example to an output embedding information 1008. The model part 1004 performs this task by multiplying the input embedding information by a base portion (W_{F}) of fixed weights, to produce the output embedding information 1008 defined by W_{F}x. A right-most path of the training logic 1002 shows a forward pass in which two feed-forward layers (1010, 1012) map the input embedding information 1006 to output embedding information 1014. More specifically, the first feed-forward layer 1010 multiplies the input embedding information 1006 by a first weight matrix A, to produce intermediate embedding information 1016 having a value Ax. The weight matrix A is randomly initialized at the start of a training operation. The second feed-forward layer 1012 multiples a second weight matrix B by the intermediate embedding information 1016, to produce the final output embedding information 1014 given by BAx. The weight matrix B is set to zero at the beginning of the training operation. A summation component 1018 adds the output embedding information 1008 produced by left-most path with the output embedding information 1014 produced by the right-most path, to produce a combined output embedding 1020 given by h=W_{F}x+ABx.

Although not shown in FIG. 10, other model parts in the machine-trained model perform the same transformations shown in FIG. 10. An instance of output embedding information produced by a parent model part serves as input embedding information to one of its child model parts. Upon generating a final output result using a leaf model part, the training system 902 calculates loss associated this output result, and based thereon, uses backpropagation to adjust the model-variance weights. In the context of FIG. 10, the training system 902 uses the loss to update the weights of the weight matrices (A, B), while holding the weight matrix (W_{F}) of the left-most path fixed.

In some implementations, the weight matrix W_{F} has dimensions of d×k, while the weight matrix A has the dimensions of r×k and the matrix B has the dimensions of d×r. The multiplication of matrix A by matrix B therefore yields a matrix having the same size as the matrix W_{F}. The symbol r refers to the rank. Rank r is typically much smaller than d or k (e.g., r»min (d,k)). As such, there are much less model weights to learn in the matrices A and B, compared to the weights in the base matrix W_{F}. Background information on the general topic of matrix decomposition in a training operation can found at Hu, at al., “LoRA: Low-Rank Adaptation of Large Language Models,” arXiv, Cornell University, arXiv:2106.09685v2 [cs.CL], Oct. 16, 2021, 26 pages.

Other implementations used to train portions of model-variance weights use adapters. An adapter represents an additional feed-forward layer (or layers) added to a base machine-trained model. For example, an adapter can be added to the “top” of the first transformer component 606 of FIG. 6, and can operate on the output embedding information 626 of the first transformer component 606. The training system 902 first trains the base model weights of the main RTL path 108, and then trains all of the weights of the adapters, while optionally holding the base model weights fixed. General background information on the use of adapters can be found in: Houlsby, et al., “Parameter-Efficient Transfer Learning for NLP,” arXiv, Cornell University, arXiv:1902.00751v2 [cs.LG], June 2019, 13 pages; Pfeiffer, et al., “AdapterFusion: Non-Destructive Task Composition for Transfer Learning,” arXiv, Cornell University, 2005.00247v3 [cs.CL], Jan. 26, 2021, 17 pages; and Pfeiffer, et al., “AdapterHub: A Framework for Adapting Transformers,” in Proceedings of the 2020 Conference on Empirical Methods in Natural Language Processing: System Demonstrations, 2020, 9 pages.

Other implementations train portions of input information instead of portions of model-variance weights. For example, a portion of input information includes one or more vectors, each having randomly-initialized values. The training system 902 iteratively trains the values in the input information to minimize the loss function 910. At inference time, a model part trained in this manner receives an input that includes a combination of input embedding information (produced by the parent of the model part) and an instance of machine-trained input information associated with this model part. The machine-trained input information provides context information that influences the output result produced by the model part.

In summary, the training system 902 first defines the portions of base model weights to produce prescribed behavior of the machine-trained model. The training system 902 then defines portions of model-variance information to produce variations of the prescribed behavior with less information (e.g., a smaller size) compared to the portions of base model weights. The training system 902 achieves this result by training portions of model-variance weights and/or portions of input information. FIG. 10 illustrates one way to produce the portions of model-variance weights.

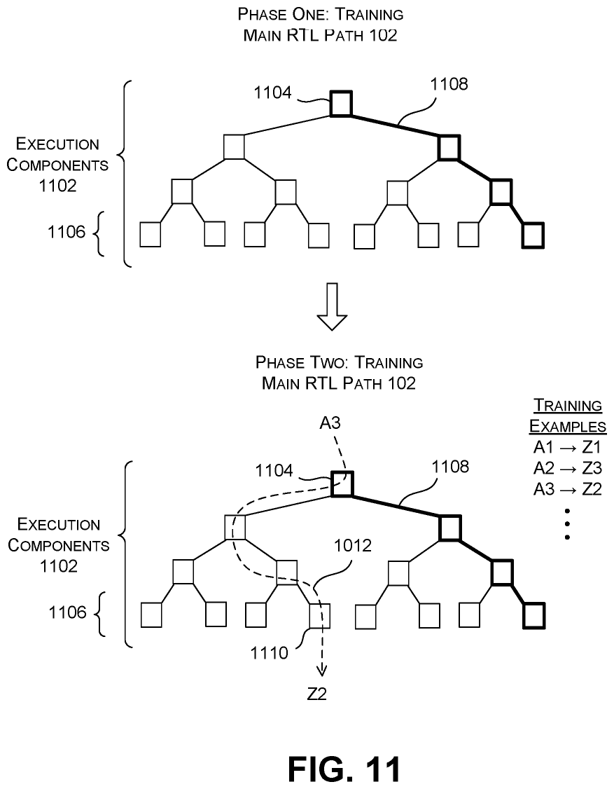

FIG. 11 shows a specific example of a training operation performed for a collection of execution components 1102. The model parts include a collection of hierarchically-connected execution components 1102. Each execution component, for instance, corresponds to the kind of execution component 502 shown in FIG. 5. The execution components 1102 include a root execution component 1104 associated with the root node of the data structure 102. The execution components 1102 also include leaf execution components 1106 associated with leaf nodes of the data structure 102. Different input embeddings terminate in different leaf execution components 1106. In a first phase, the training system 902 trains execution components associated with the main RTL path 1108 shown in FIG. 1. In a second phase, the training system 902 trains the remaining portions of model-variance weights of the data structure 102 while optionally holding the weights of the main RTL path 1108 fixed.

Consider an illustrative training operation in the context of the second phase. The training system 902 feeds an input embedding associated with input information A3 into the root execution component 1104. Assume that a particular leaf execution component 1110 delivers an output result corresponding to input information Z2. The execution components that play a role in delivering this output result are those along the path 1112 shown in FIG. 11. The execution of the execution component 1110, for instance, requires access to a portion of a model-variance weights and a corresponding portion of base weights.

Assume that the ground-truth output information for this training example indicates that input information A3 is indeed expected to map to the output result Z2. In this case, the training component 904 adjusts the weights of the machine-trained model (except the base portions of model weights) to reinforce the configuration of the machine-trained model that has produced the correct outcome. If the output result does not match the ground-truth output information, the training component 904 adjusts the weights of the machine-trained model (except the base portions of the model weights) to penalize the configuration that has produced the faulty outcome.

Note that, other than the expectation that a particular instance of input embedding information will result in a particular instance of output embedding information, the training component 904 does not dictate the course of the path 1112 that will lead to the correct output result (Z2). Rather, the training component 904 automatically determines the path 1112 over the course of its iterative training operation.

In some implementations, the training system 902 uses one or more additional techniques to reduce the size of its model weights. These techniques include knowledge distillation, pruning, and data compression. The training system 902 performs one or more of these techniques during training of the machine-trained model, and/or after training of the machine-trained model.

Knowledge distillation uses a machine-trained teacher model to assist in training a smaller student model. In some implementations, the teacher model processes input examples to generate ground-truth output results. Knowledge distribution uses the ground-truth output results to train the student model. By this process, the knowledge of the more powerful, but more resource-intensive, teacher model is transferred to (or distilled in) the smaller and more resource-efficient student model.

Pruning operates to eliminate parameter values that have the least impact on the operation of a machine-trained model. For example, the pruning operation may remove (e.g., zero-out) weights used in the attention and/or feed-forward layers of the machine-trained model. Unstructured pruning specifically operates by eliminating the least impactful parameter values, without regard to what parameter values are eliminated. Structured pruning operates by eliminating selected groups of weights, such as selected rows and/or columns of weights, and/or selected n×m blocks of weights. There are likewise different techniques for deciding which parameter values to remove. Magnitude pruning removes weights having magnitudes closest to zero. Movement pruning removes weights that move toward zero from one fine-tuning training iteration to the next.

Compression reduces the size of an existing machine-trained model. For instance, Principal Component Analysis (PCA) transforms parameter values to a space with fewer dimensions, compared to an original parameter values. Quantization reduces the size of parameter values by changing the format used to express the parameter values, e.g., by converting floating point information into integer form. Illustrative quantized formats include TensorFloat32 (GF32), half-precision floating point, signed n-bit integer, etc.

General background information on the topic of model size reduction can be found in Xu, et al., “A Survey on Model Compression and Acceleration for Pretrained Language Models,” in arXiv archive, Cornell University, arXiv:2202.07105v2 [cs.CL], November 2022, 10 pages.

### G. Illustrative Processes

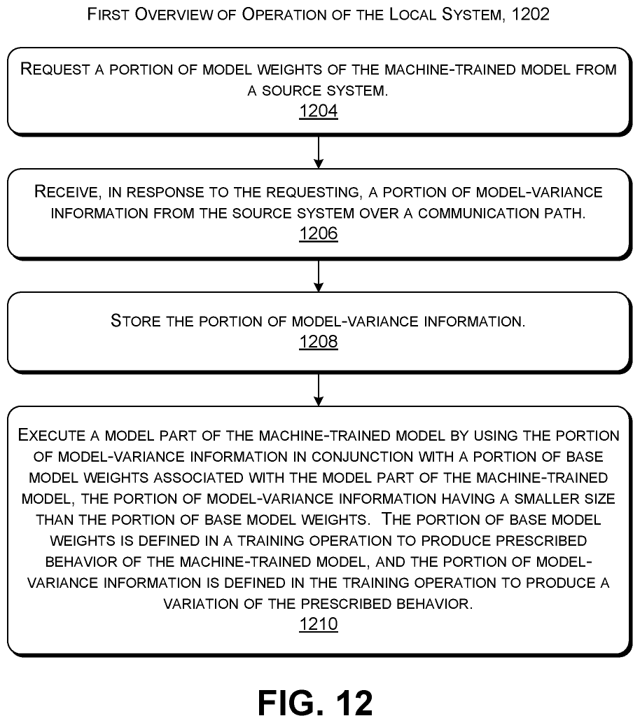

FIGS. 12-14 show three processes that represent an overview of the operation of the execution framework 402 of FIG. 4. Each of the processes is expressed as a series of operations performed in a particular order. But the order of these operations is merely representative, and the operations are capable of being varied in other implementations. Further, any two or more operations described below can be performed in a parallel manner. In one implementation, the blocks shown in the processes that pertain to processing-related functions are implemented by the computing equipment described in connection with FIGS. 15 and 16.

More specifically, FIG. 12 shows a process 1202 for executing a machine-trained model in a local system (e.g., the local system 406). In block 1204, the local system requests a portion of model weights of the machine-trained model from a source system (e.g., the source system 404). In block 1206, the local system receives, in response to the requesting, a portion of model-variance information from the source system over a communication path. In block 1208, the local system stores the portion of model-variance information. In block 1210, the local system executes a model part of the machine-trained model by using the portion of model-variance information in conjunction with a portion of base model weights associated with the model part of the machine-trained model, the portion of model-variance information having a smaller size than the portion of base model weights. The portion of base model weights is defined in a training operation to produce prescribed behavior of the machine-trained model, and the portion of model-variance information is defined in the training operation to produce a variation of the prescribed behavior.

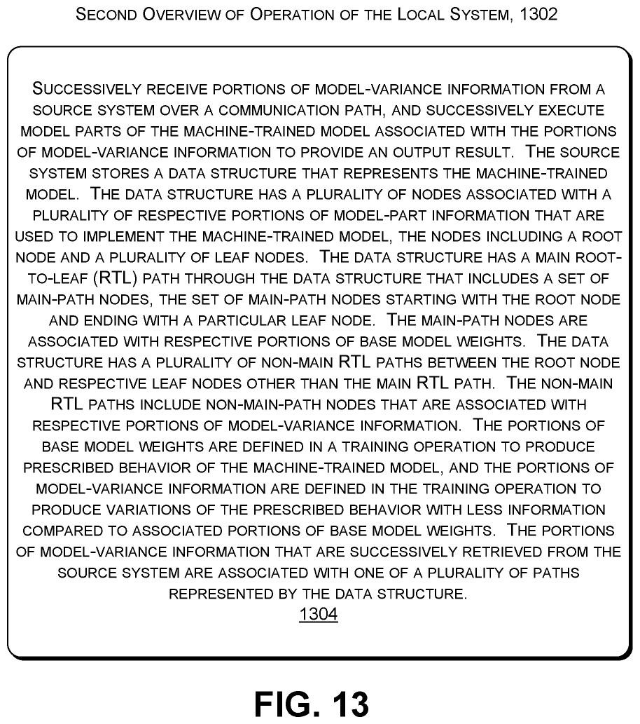

FIG. 13 shows another process 1302 for executing a machine-trained model in a local system (e.g., the local system 406). In block 1304, the local system successively receives portions of model-variance information from a source system (e.g., the source system 404) over a communication path, and successively executes model parts of the machine-trained model associated with the portions of model-variance information to provide an output result. The source system stores a data structure (e.g., the data structure 102) that represents the machine-trained model, the data structure having a plurality of nodes associated with a plurality of respective portions of model-part information that are used to implement the machine-trained model, the nodes including a root node (e.g., the root node 104) and a plurality of leaf nodes (e.g., the leaf nodes 106). The data structure has a main root-to-leaf (RTL) path (e.g., the main RTL path 108) through the data structure that includes a set of main-path nodes, the set of main-path nodes starting with the root node and ending with a particular leaf node, the main-path nodes being associated with respective portions of base model weights. The data structure has a plurality of non-main RTL paths between the root node and respective leaf nodes other than the main RTL path, the non-main RTL paths including non-main-path nodes that are associated with respective portions of model-variance information. The portions of base model weights are defined in a training operation to produce prescribed behavior of the machine-trained model, and the portions of model-variance information are defined in the training operation to produce variations of the prescribed behavior with less information compared to associated portions of base model weights. The portions of model-variance information that are successively retrieved from the source system are associated with one of a plurality of paths represented by the data structure.

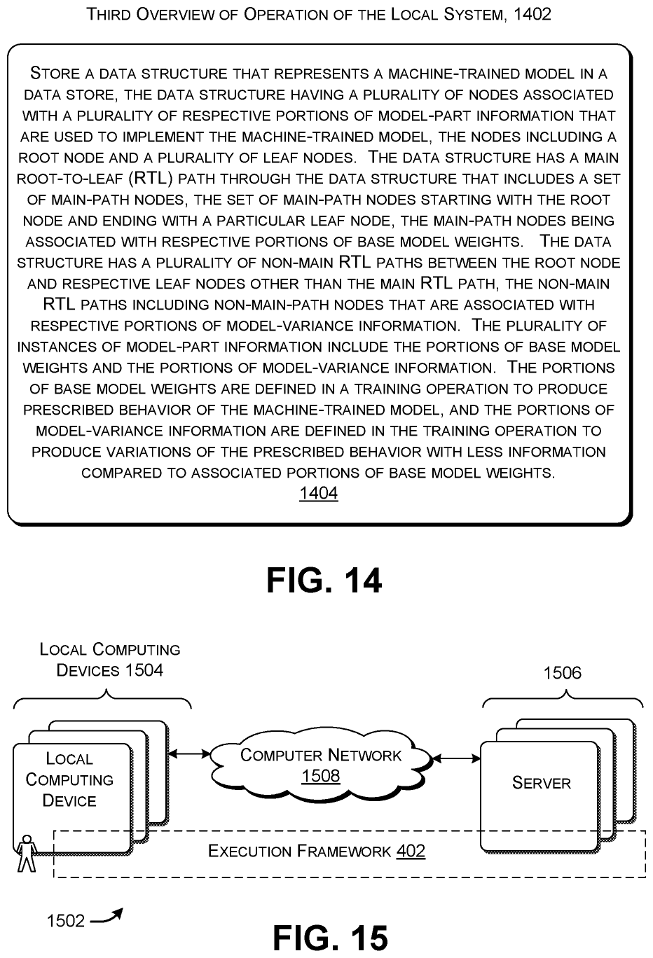

FIG. 14 shows a process 1402 performed by a source system (e.g., the source system 404) or a local system (e.g., the local system 406). In block 1404, the source system or the local system stores a data structure (e.g., the data structure 102) that represents a machine-trained model in a data store (e.g., the system store 410 or the local store 418), the data structure having a plurality of nodes associated with a plurality of respective portions of model-part information that are used to implement the machine-trained model, the nodes including a root node (e.g., the root node 104) and a plurality of leaf nodes (e.g., the leaf nodes 106). The data structure has a main root-to-leaf (RTL) path (e.g., the main RTL path 108) through the data structure that includes a set of main-path nodes, the set of main-path nodes starting with the root node and ending with a particular leaf node, the main-path nodes being associated with respective portions of base model weights. The data structure has a plurality of non-main RTL paths between the root node and respective leaf nodes other than the main RTL path, the non-main RTL paths including non-main-path nodes that are associated with respective portions of model-variance information. The plurality of instances of model-part information include the portions of base model weights and the portions of model-variance information. The portions of base model weights are defined in a training operation to produce prescribed behavior of the machine-trained model. The portions of model-variance information are defined in the training operation to produce variations of the prescribed behavior with less information compared to associated portions of base model weights.

### H. Illustrative Computing Functionality

FIG. 15 shows computing equipment 1502 that, in some implementations, is used to implement the execution framework 402 of FIG. 4. The computing equipment 1502 includes a set of local computing devices 1504 coupled to a set of servers 1506 via a computer network 1508. Each local computing device corresponds to any type of computing device, including any of a desktop computing device, a laptop computing device, a handheld computing device of any type (e.g., a smartphone or a tablet-type computing device), a mixed reality device, an intelligent appliance, a wearable computing device, an Internet-of-Things (IoT) device, a gaming system, a media device, a vehicle-borne computing system, any type of robot computing system, a computing system in a manufacturing system, etc. In some implementations, the computer network 1508 is implemented as a local area network, a wide area network (e.g., the Internet), one or more point-to-point links, or any combination thereof.

The dashed-line box in FIG. 15 indicates that the functionality of the execution framework 402 is capable of being spread across the local computing devices 1504 and/or the servers 1506 in any manner. For instance, in some cases, one or more of the servers 1506 implement the entirety of the source system 404, and each local computing device, or each group of local-affiliated local computing devices, implements an instance of the local system 406. In one manner of use, for instance, a user may interacts with a local computing device to submit input information to the local system 406, e.g. via a browser interface of a browser program running on the local computing device. The local computing device then obtains portions of model weights from the source system 404 on an as-needed basis in the manner described above. The local computing device locally runs the machine-trained model based on the portions of model weights it obtains in this streamed fashion. In other implementations, a local computing device is initialized to store all (or some) of the weights associated with the data structure 102. Such a local computing device requires no (or reduced) interaction with servers that implement the source system 404.

FIG. 16 shows a computing system 1602 that, in some implementations, is used to implement any aspect of the mechanisms set forth in the above-described figures. For instance, in some implementations, the type of computing system 1602 shown in FIG. 16 is used to implement any local computing device or any server shown in FIG. 15. In all cases, the computing system 1602 represents a physical and tangible processing mechanism.

The computing system 1602 includes a processing system 1604 including one or more processors. The processor(s) include one or more central processing units (CPUs), and/or one or more graphics processing units (GPUs), and/or one or more application specific integrated circuits (ASICs), and/or one or more neural processing units (NPUs), and/or one or more tensor processing units (TPUs), etc. More generally, any processor corresponds to a general-purpose processing unit or an application-specific processor unit.

The computing system 1602 also includes computer-readable storage media 1606, corresponding to one or more computer-readable media hardware units. The computer-readable storage media 1606 retains any kind of information 1608, such as machine-readable instructions, settings, model weights, and/or other data. In some implementations, the computer-readable storage media 1606 includes one or more solid-state devices, one or more magnetic hard disks, one or more optical disks, magnetic tape, etc. Any instance of the computer-readable storage media 1606 uses any technology for storing and retrieving information. Further, any instance of the computer-readable storage media 1606 represents a fixed or removable unit of the computing system 1602. Further, any instance of the computer-readable storage media 1606 provides volatile and/or non-volatile retention of information.

More generally, any of the storage resources described herein, or any combination of the storage resources, is to be regarded as a computer-readable medium. In many cases, a computer-readable medium represents some form of physical and tangible entity. The term computer-readable medium also encompasses propagated signals, e.g., transmitted or received via a physical conduit and/or air or other wireless medium. However, the specific term “computer-readable storage medium” or “storage device” expressly excludes propagated signals per se in transit, while including all other forms of computer-readable media; a computer-readable storage medium or storage device is “non-transitory” in this regard.

The computing system 1602 utilizes any instance of the computer-readable storage media 1606 in different ways. For example, in some implementations, any instance of the computer-readable storage media 1606 represents a hardware memory unit (such as random access memory (RAM)) for storing information during execution of a program by the computing system 1602, and/or a hardware storage unit (such as a hard disk) for retaining/archiving information on a more permanent basis. In the latter case, the computing system 1602 also includes one or more drive mechanisms 1610 (such as a hard drive mechanism) for storing and retrieving information from an instance of the computer-readable storage media 1606.

In some implementations, the computing system 1602 performs any of the functions described above when the processing system 1604 executes computer-readable instructions stored in any instance of the computer-readable storage media 1606. For instance, in some implementations, the computing system 1602 carries out computer-readable instructions to perform each block of the processes described with reference to FIGS. 12-14. FIG. 16 generally indicates that hardware logic circuitry 1612 includes any combination of the processing system 1604 and the computer-readable storage media 1606.

In addition, or alternatively, the processing system 1604 includes one or more other configurable logic units that perform operations using a collection of logic gates. For instance, in some implementations, the processing system 1604 includes a fixed configuration of hardware logic gates, e.g., that are created and set at the time of manufacture, and thereafter unalterable. In addition, or alternatively, the processing system 1604 includes a collection of programmable hardware logic gates that are set to perform different application-specific tasks. The latter category of devices includes programmable array logic devices (PALs), generic array logic devices (GALs), complex programmable logic devices (CPLDs), field-programmable hate arrays (FPGAs), etc. In these implementations, the processing system 1604 effectively incorporates a storage device that stores computer-readable instructions, insofar as the configurable logic units are configured to execute the instructions and therefore embody or store these instructions.

In some cases (e.g., in the case in which the computing system 1602 represents a user computing device), the computing system 1602 also includes an input/output interface 1614 for receiving various inputs (via input devices 1616), and for providing various outputs (via output devices 1618). Illustrative input devices include a keyboard device, a mouse input device, a touchscreen input device, a digitizing pad, one or more static image cameras, one or more video cameras, one or more depth camera systems, one or more microphones, a voice recognition mechanism, any position-determining devices (e.g., GPS devices), any movement detection mechanisms (e.g., accelerometers and/or gyroscopes), etc. In some implementations, one particular output mechanism includes a display device 1620 and an associated graphical user interface presentation (GUI) 1622. The display device 1620 corresponds to a liquid crystal display device, a light-emitting diode display (LED) device, a cathode ray tube device, a projection mechanism, etc. Other output devices include a printer, one or more speakers, a haptic output mechanism, an archival mechanism (for storing output information), etc. In some implementations, the computing system 1602 also includes one or more network interfaces 1624 for exchanging data with other devices via one or more communication conduits 1626. One or more communication buses 1628 communicatively couple the above-described units together.

The communication conduit(s) 1626 is implemented in any manner, e.g., by a local area computer network, a wide area computer network (e.g., the Internet), point-to-point connections, or any combination thereof. The communication conduit(s) 1626 include any combination of hardwired links, wireless links, routers, gateway functionality, name servers, etc., governed by any protocol or combination of protocols.

FIG. 16 shows the computing system 1602 as being composed of a discrete collection of separate units. In some cases, the collection of units corresponds to discrete hardware units provided in a computing device chassis having any form factor. FIG. 16 shows illustrative form factors in its bottom portion. In other cases, the computing system 1602 includes a hardware logic unit that integrates the functions of two or more of the units shown in FIG. 16. For instance, in some implementations, the computing system 1602 includes a system on a chip (SoC or SOC), corresponding to an integrated circuit that combines the functions of two or more of the units shown in FIG. 16.

The following summary provides a set of illustrative examples of the technology set forth herein.
(A1) According to one aspect, a method (e.g., the process 1202) is described for executing a machine-trained model in a local system (e.g., the local system 406. The method includes: requesting (e.g., in block 1204) a portion of model weights of the machine-trained model from a source system (e.g., the source system 404); receiving (e.g., in block 1206), in response to the requesting, a portion of model-variance information from the source system over a communication path (e.g., the network 408); and storing (e.g., in block 1208) the portion of model-variance information. The further includes executing (e.g., in block 1210) a model part of the machine-trained model by using the portion of model-variance information in conjunction with a portion of base model weights associated with the model part of the machine-trained model, the portion of model-variance information having a smaller size than the portion of base model weights. Further, the portion of base model weights is defined in a training operation to produce prescribed behavior of the machine-trained model, and the portion of model-variance information is defined in the training operation to produce a variation of the prescribed behavior.
(A2) According to some implementations of the method of A1, the portion of model-variance information includes a portion of model-variance weights.
(A3) According to some implementations of the method of A1, the portion of model-variance information includes an instance of machine-trained input information.
(A4) According to some implementations of any of the methods of A1-A3, wherein the source system stores a data structure in a data store that represents the machine-trained model. The data structure has a plurality of nodes associated with a plurality of respective portions of model-part information that are used to implement the machine-trained model, the nodes including a root node and a plurality of leaf nodes. The data structure has a main root-to-leaf (RTL) path through the data structure that includes a set of main-path nodes, the set of main-path nodes starting with the root node and ending with a particular leaf node, the main-path nodes being associated with respective portions of base model weights. The data structure has a plurality of non-main RTL paths between the root node and respective leaf nodes other than the main RTL path, the non-main RTL paths including non-main-path nodes that are associated with respective portions of model-variance information.
(A5) According to some implementations of the method of A4, the local system is initialized to store all the portions of base model weights.
(A6) According to some implementations of any of the methods of A1-A5, the executing involves identifying a next portion of model-variance information to request from the source system.
(A7) According to some implementations of any of the methods of A1-A6, the executing involves performing a transformer-based operation.
(A8) According to some implementations of any of the methods of A1-A7, the method further includes locally retaining the portion of model-variance information in the data store as a local-part portion, and retrieving the local-part portion from the data store upon a subsequent need for the local-part portion.
(A9) According to some implementations of the method of A8, the local system includes a local computing device that stores all local-part portions of the local system.
(A10) According to some implementations of the method of A8, the local system includes a first local computing device that stores first local-part portions of the local system, and a second local computing device that stores second local-part portions of the local system, the second local-part portions being different than the first local-part portions, at least in part.
(B1) According to another aspect, a method (e.g., the process 1402) includes an operation (e.g., in block 1404) of storing a data structure (e.g., the data structure 102) that represents a machine-trained model in a data store (e.g., the system store 410 or the local store 418). The data structure has a plurality of nodes associated with a plurality of respective portions of model-part information that are used to implement the machine-trained model, the nodes including a root node (e.g., the root node 104) and a plurality of leaf nodes (e.g., the leaf nodes 106). The data structure has a main root-to-leaf (RTL) path (e.g., the main RTL path 108) through the data structure that includes a set of main-path nodes, the set of main-path nodes starting with the root node and ending with a particular leaf node, the main-path nodes being associated with respective portions of base model weights. The data structure has a plurality of non-main RTL paths between the root node and respective leaf nodes other than the main RTL path, the non-main RTL paths including non-main-path nodes that are associated with respective portions of model-variance information. The plurality of instances of model-part information include the portions of base model weights and the portions of model-variance information. The portions of base model weights are defined in a training operation to produce prescribed behavior of the machine-trained model, and the portions of model-variance information are defined in the training operation to produce variations of the prescribed behavior with less information compared to associated portions of base model weights.
(C1) According to another aspect, a method (e.g., the process 1302) is described for executing a machine-trained model in a local system (e.g., the local system 406). The method includes (e.g., in block 1304) successively receiving portions of model-variance information from a source system (e.g., the source system 404) over a communication path (e.g., the network 408), and successively executing model parts of the machine-trained model associated with the portions of model-variance information to provide an output result. The source system stores a data structure (e.g., the data structure 102) that represents the machine-trained model. The data structure has a plurality of nodes associated with a plurality of respective portions of model-part information that are used to implement the machine-trained model, the nodes including a root node (e.g., the root node 106) and a plurality of leaf nodes (e.g., the leaf nodes 106). The data structure has a main root-to-leaf (RTL) path (e.g., the main RTL path 108) through the data structure that includes a set of main-path nodes, the set of main-path nodes starting with the root node and ending with a particular leaf node, the main-path nodes being associated with respective portions of base model weights. The data structure has a plurality of non-main RTL paths between the root node and respective leaf nodes other than the main RTL path, the non-main RTL paths including non-main-path nodes that are associated with respective portions of model-variance information. The portions of base model weights are defined in a training operation to produce prescribed behavior of the machine-trained model, and the portions of model-variance information are defined in the training operation to produce variations of the prescribed behavior with less information compared to associated portions of base model weights. The portions of model-variance information that are successively retrieved from the source system are associated with one of a plurality of paths represented by the data structure.

In yet another aspect, some implementations of the technology described herein include a computing system (e.g., the computing system 1602) that includes a processing system (e.g., the processing system 1604) having a processor. The computing system also includes a storage device (e.g., the computer-readable storage media 1606) for storing computer-readable instructions (e.g., information 1608). The processing system executes the computer-readable instructions to perform any of the methods described herein (e.g., any individual method of the methods of A1-A10, B1, or C1).

In yet another aspect, some implementations of the technology described herein include a computer-readable storage medium (e.g., the computer-readable storage media 1606) for storing computer-readable instructions (e.g., the information 1608). A processing system (e.g., the processing system 1604) executes the computer-readable instructions to perform any of the operations described herein (e.g., the operations in any individual method of the methods of A1-A10, B1, or C1).

More generally stated, any of the individual elements and steps described herein are combinable into any logically consistent permutation or subset. Further, any such combination is capable of being manifested as a method, device, system, computer-readable storage medium, data structure, article of manufacture, graphical user interface presentation, etc. The technology is also expressible as a series of means-plus-format elements in the claims, although this format should not be considered to be invoked unless the phrase “means for” is explicitly used in the claims.

As to terminology used in this description, the phrase “configured to” encompasses various physical and tangible mechanisms for performing an identified operation. The mechanisms are configurable to perform an operation using the hardware logic circuitry 1612 of FIG. 16. The term “logic” likewise encompasses various physical and tangible mechanisms for performing a task. For instance, each processing-related operation illustrated in the flowcharts of FIGS. 12-14 corresponds to a logic component for performing that operation.

This description may have identified one or more features as optional. This type of statement is not to be interpreted as an exhaustive indication of features that are to be considered optional; generally, any feature is to be considered as an example, although not explicitly identified in the text, unless otherwise noted. Further, any mention of a single entity is not intended to preclude the use of plural such entities; similarly, a description of plural entities in the specification is not intended to preclude the use of a single entity. As such, a statement that an apparatus or method has a feature X does not preclude the possibility that it has additional features. Further, any features described as alternative ways of carrying out identified functions or implementing identified mechanisms are also combinable together in any combination, unless otherwise noted.

In terms of specific terminology, the term “plurality” or “plural” or the plural form of any term (without explicit use of “plurality” or “plural”) refers to two or more items, and does not necessarily imply “all” items of a particular kind, unless otherwise explicitly specified. The term “at least one of” refers to one or more items; reference to a single item, without explicit recitation of “at least one of” or the like, is not intended to preclude the inclusion of plural items, unless otherwise noted. Further, the descriptors “first,” “second,” “third,” etc. are used to distinguish among different items, and do not imply an ordering among items, unless otherwise noted. The phrase “A and/or B” means A, or B, or A and B. The phrase “any combination thereof” refers to any combination of two or more elements in a list of elements. Further, the terms “comprising,” “including,” and “having” are open-ended terms that are used to identify at least one part of a larger whole, but not necessarily all parts of the whole. A “set” is a group that includes one or more members. The phrase “A corresponds to B” means “A is B” in some contexts. Finally, the terms “exemplary” or “illustrative” refer to one implementation among potentially many implementations.

In closing, the functionality described herein is capable of employing various mechanisms to ensure that any user data is handled in a manner that conforms to applicable laws, social norms, and the expectations and preferences of individual users. For example, the functionality is configurable to allow a user to expressly opt in to (and then expressly opt out of) the provisions of the functionality. The functionality is also configurable to provide suitable security mechanisms to ensure the privacy of the user data (such as data-sanitizing mechanisms, encryption mechanisms, and/or password-protection mechanisms).

Further, the description may have set forth various concepts in the context of illustrative challenges or problems. This manner of explanation is not intended to suggest that others have appreciated and/or articulated the challenges or problems in the manner specified herein. Further, this manner of explanation is not intended to suggest that the subject matter recited in the claims is limited to solving the identified challenges or problems; that is, the subject matter in the claims may be applied in the context of challenges or problems other than those described herein.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A computer-readable storage medium for storing computer-readable instructions, a processing system executing the computer-readable instructions to perform operations, the operations comprising:
storing a data structure that represents a machine-trained model in a data store,
the data structure having a plurality of nodes associated with a plurality of respective portions of model-part information that are used to implement the machine-trained model, the nodes including a root node and a plurality of leaf nodes,
the data structure having a main root-to-leaf (RTL) path through the data structure that includes a set of main-path nodes, the set of main-path nodes starting with the root node and ending with a particular leaf node, the main-path nodes being associated with respective portions of base model weights,
the data structure having a plurality of non-main RTL paths between the root node and respective leaf nodes other than the main RTL path, the non-main RTL paths including non-main-path nodes that are associated with respective portions of model-variance information,
the plurality of instances of model-part information including the portions of base model weights and the portions of model-variance information, and
the portions of base model weights being defined in a training operation to produce prescribed behavior of the machine-trained model, and the portions of model-variance information being defined in the training operation to produce variations of the prescribed behavior with less information compared to associated portions of base model weights.

2. The computer-readable storage medium of claim 1, wherein the portions of model-variance information include respective portions of model-variance weights.

3. The computer-readable storage medium of claim 1, wherein the portions of model-variance information include respective instances of machine-trained input information.

4. A method for executing a machine-trained model in a local system, comprising:
requesting a portion of model weights of the machine-trained model from a source system;
receiving, in response to the requesting, a portion of model-variance information from the source system over a communication path;
storing the portion of model-variance information; and
executing a model part of the machine-trained model by using the portion of model-variance information in conjunction with a portion of base model weights associated with the model part of the machine-trained model, the portion of model-variance information having a smaller size than the portion of base model weights,
the portion of base model weights being defined in a training operation to produce prescribed behavior of the machine-trained model, and the portion of model-variance information being defined in the training operation to produce a variation of the prescribed behavior.

5. The method of claim 4, wherein the portion of model-variance information includes a portion of model-variance weights.

6. The method of claim 4, wherein the portion of model-variance information includes an instance of machine-trained input information.

7. The method of claim 4,
wherein the source system stores a data structure in a data store that represents the machine-trained model,
the data structure having a plurality of nodes associated with a plurality of respective portions of model-part information that are used to implement the machine-trained model, the nodes including a root node and a plurality of leaf nodes,
the data structure having a main root-to-leaf (RTL) path through the data structure that includes a set of main-path nodes, the set of main-path nodes starting with the root node and ending with a particular leaf node, the main-path nodes being associated with respective portions of base model weights, and
the data structure having a plurality of non-main RTL paths between the root node and respective leaf nodes other than the main RTL path, the non-main RTL paths including non-main-path nodes that are associated with respective portions of model-variance information.

8. The method of claim 7, wherein the local system is initialized to store all the portions of base model weights.

9. The method of claim 4, wherein the executing involves identifying a next portion of model-variance information to request from the source system.

10. The method of claim 4, wherein the executing involves performing a transformer-based operation.

11. The method of claim 4, further comprising locally retaining the portion of model-variance information in the data store as a local-part portion, and retrieving the local-part portion from the data store upon a subsequent need for the local-part portion.

12. The method of claim 11, wherein the local system includes a local computing device that stores all local-part portions of the local system.

13. The method of claim 11, wherein the local system includes a first local computing device that stores first local-part portions of the local system, and a second local computing device that stores second local-part portions of the local system, the second local-part portions being different than the first local-part portions, at least in part.

14. A local system for executing a machine-trained model, comprising:
a data store for storing computer-readable instructions;
a processing system for executing the computer-readable instructions in the data store, to perform operations including:
successively receiving portions of model-variance information from a source system over a communication path, and successively executing model parts of the machine-trained model associated with the portions of model-variance information to provide an output result,
the source system storing a data structure that represents the machine-trained model,
the data structure having a plurality of nodes associated with a plurality of respective portions of model-part information that are used to implement the machine-trained model, the nodes including a root node and a plurality of leaf nodes,
the data structure having a main root-to-leaf (RTL) path through the data structure that includes a set of main-path nodes, the set of main-path nodes starting with the root node and ending with a particular leaf node, the main-path nodes being associated with respective portions of base model weights,
the data structure having a plurality of non-main RTL paths between the root node and respective leaf nodes other than the main RTL path, the non-main RTL paths including non-main-path nodes that are associated with respective portions of model-variance information,
the portions of base model weights being defined in a training operation to produce prescribed behavior of the machine-trained model, and the portions of model-variance information being defined in the training operation to produce variations of the prescribed behavior with less information compared to associated portions of base model weights, and
the portions of model-variance information that are successively retrieved from the source system being associated with one of a plurality of paths represented by the data structure.

15. The local system of claim 14, wherein the portions of model-variance information expressed by the data structure include respective portions of model-variance weights.

16. The local system of claim 14, wherein the portions of model-variance information expressed by the data structure include respective instances of machine-trained input information.

17. The local system of claim 14, wherein executing a particular model part of the machine-trained model involves identifying a next model part of the machine-trained model to execute.

18. The local system of claim 14, wherein executing a particular model part of the machine-trained model produces a result that depends on a particular portion of base model weights and a corresponding portion of model-variance information.

19. The local system of claim 14, further comprising locally retaining a particular portion of model-variance information that is received as a local-part portion, and reusing the local-part portion upon a subsequent need for the local-part portion.

20. The local system of claim 14, wherein the local system is initialized to store all the portions of base model weights represented by the data structure.
